(19) United States
(12) Patent Application Publication
(10) Pub. No.: US 2007/0247623 A1
(43) Pub. Date: Oct. 25, 2007

(54) Polarization measuring devices, ellipsometers and polarization measuring methods

(76) Inventors: Dong-wan Kim, Seongnam-si (KR); Dong-gun Lee, Hwaseong-si (KR); Kyoung-yoon Bang, Ansan-si (KR)

Correspondence Address: HARNESS, DICKEY & PIERCE, P.L.C., P.O. BOX 8910, RESTON, VA, 20195, US

(21) Appl. No.: 11/723,992

(22) Filed: Mar. 23, 2007

(30) Foreign Application Priority Data
Mar. 23, 2006 (KR) 10-2006-0026699

(51) Int. Cl. G01J 4/00

(52) U.S. Cl. 356/364

(57) ABSTRACT

A polarization measuring device includes a diffraction grating and a detector. The diffraction grating is configured to diffract incident light to observe the polarization state of the light. The detector is configured to receive the light diffracted by the diffraction grating and display the polarization state of the light.

### PRIORITY STATEMENT

This non-provisional U.S. patent application claims priority under 35 U.S.C. § 119 to Korean Patent Application No. 10-2006-0026699 filed on Mar. 23, 2006, in the Korean Intellectual Property Office (KIPO), the entire contents of which is incorporated herein by reference.

### BACKGROUND

### Description of the Related Art

In ellipsometry, involves analyzing a polarization state of light reflected from a work piece to obtain information regarding the work piece. In one example, when light having a particular polarization state is incident on and reflected by the work piece, the polarization state may change. The polarization state of the reflected light may be analyzed to obtain information concerning the work piece. By measuring the change in the polarization state of light, surface, film structure, physical properties of the work piece and/or mineral properties of a substance may be analyzed and examined. Ellipsometry may also be used to measure and/or analyze thickness, density, refractive index, composition ratio, etc. of a thin film.

An ellipsometer is a device for measuring a polarization state of light. Related art ellipsometers may be classified as a reflective or transmissive, passive or active, null or photometric, or an interferometric ellipsometer. According to the range of the measuring wavelength, ellipsometers may be classified as single wavelength, spectroscopic, infrared ray, microwave, deep UV, vacuum UV, extreme UV, etc.

A related art ellipsometer may include a polarizer that linearly polarizes light, an analyzer that measures a polarization state of reflected light and a compensator that changes the phase of light. In order to measure the polarization state of light reflected from a work piece, the polarizer and the analyzer or only the polarizer are rotated and the change in the light intensity according to the rotation is measured.

### SUMMARY

Example embodiments relate to polarization measuring devices, ellipsometers and polarization measuring methods.

At least one example embodiment is directed to a polarization measuring device, which may be capable of more rapidly and/or more effectively measuring polarization. At least one other example embodiment is directed to an ellipsometer, which may be capable of more rapidly and/or more effectively measuring polarization. At least one other example embodiment is directed to a polarization measuring method, which may be capable of more rapidly and/or more effectively measuring polarization.

According to at least one example embodiment, a polarization measuring device may include a diffraction grating configured to diffract incident light to determine the polarization state of the light and a detector configured to receive the light diffracted by the diffraction grating and display the polarization state of the light.

According to at least one other example embodiment, an ellipsometer may include a light source configured to emit light, a polarizer configured to polarize the light emitted from the light source, and direct the polarized light toward a work piece, a circular diffraction grating configured to diffract the light to observe a polarization state of the light reflected from the work piece, and a detector configured to receive the diffracted light and display the polarization state of the light.

According to at least one other example embodiment, a method of measuring a polarization state of light may include diffracting incident light to observe the polarization of the light by transmitting the light through a diffraction grating, and receiving the light diffracted by the diffraction grating and displaying the polarization state of the light.

According to at least one other example embodiment, a method of measuring a polarization state of light may include polarizing emitted light such that the light is incident on a work piece, diffracting the light to observe a polarization state by allowing the light reflected from the work piece to pass through the circular diffraction grating, and receiving the light diffracted by the circular diffraction grating to display the polarization state of the light.

According to at least one other example embodiment, a polarization measuring device may include a diffraction grating configured to diffract incident light to check the polarization state of the light, and a detector configured to receive the diffracted light and display data indicative of the polarization state of the light.

According to at least one other example embodiment, an ellipsometer may include a light source configured to emit light, a polarizer configured to polarize the emitted light and direct the polarized light toward a work piece, and a polarization measuring device. The polarization measuring device may include a diffraction grating configured to diffract incident light to check the polarization state of the light, and a detector configured to receive the diffracted light and display data indicative of the polarization state of the light.

According to at least one other example embodiment, a method of measuring a polarization state of light may include diffracting incident light to check a polarization state of the light by transmitting the light through a diffraction grating, and detecting and displaying data indicative of the polarization state of the diffracted light at a detector.

According to at least one other example embodiment, a polarization measuring method may include emitting and polarizing light, directing the polarized light toward a work piece to generate the incident light, diffracting incident light to check a polarization state of the light by transmitting the light through a diffraction grating, and detecting and displaying data indicative of the polarization state of the diffracted light at a detector.

According to at least some example embodiments, the diffraction grating may include a grating having slits. The diffraction grating may have an adjustable transmittance, which is adjustable according to a polarization direction of the light by adjusting at least one of an interval and a slit depth of the grating. The diffraction grating may be a circular diffraction grating, which may diffract the incident light in all directions. The detector may detect a two-dimensional distribution of the diffracted light intensity. Data indicative of a polarization state of the diffracted light may be directly extracted using a two-dimensional screen displaying the two-dimensional distribution of the light intensity.

### BRIEF DESCRIPTION OF THE DRAWINGS

The present invention will become more apparent by describing in detail example embodiments thereof with reference to the attached drawings, in which:

FIG. 1 is a diagram illustrating a polarization measuring device according to an example embodiment;

FIG. 2 is a perspective view of a circular diffraction grating of the polarization measuring device according to an example embodiment;

FIG. 3 is a plan view of the circular diffraction grating of the polarization measuring device according to an example embodiment;

FIG. 4 is a cross sectional view and a partially enlarged view of the circular diffraction grating of the polarization measuring device according to an example embodiment;

FIG. 5 is a conceptual diagram of an ellipsometer according to an example embodiment;

FIG. 6 is a graph illustrating transmittance of a TE wave and a TM wave versus a depth of a slit of the diffraction grating;

FIG. 7A is a view illustrating an image displayed on a detector when non-polarized light is irradiated onto a circular diffraction grating in the polarization measuring device according to an example embodiment;

FIG. 7B is a view illustrating an image displayed on a detector when linearly polarized light is irradiated onto a circular diffraction grating in the polarization measuring device according to an example embodiment; and

FIG. 7C is a view illustrating an image displayed on a detector when elliptically polarized light is irradiated onto a circular diffraction grating in the polarization measuring device according to an example embodiment.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

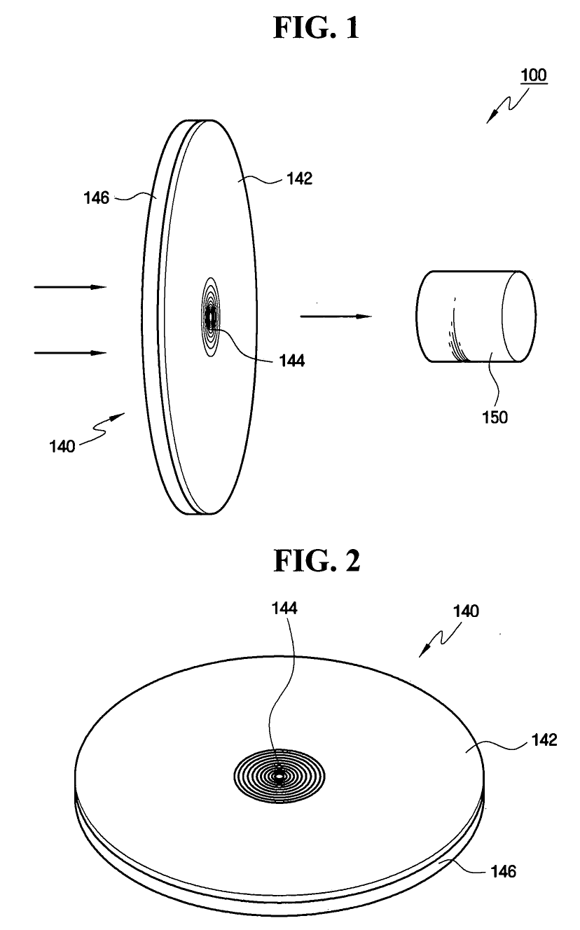

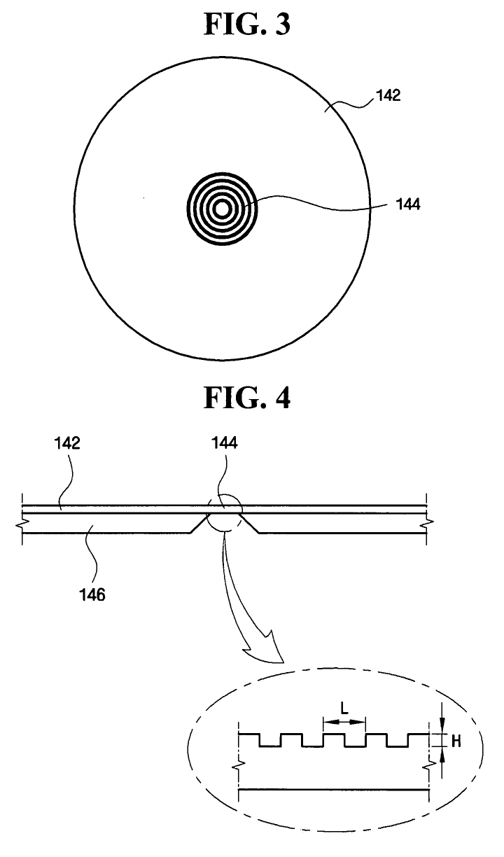

FIG. 1 is a diagram illustrating a polarization measuring device according to an example embodiment. FIG. 2 is a perspective view of a circular diffraction grating 140 shown in FIG. 1. FIG. 3 is a plan view of the circular diffraction grating 140, and FIG. 4 is a cross sectional view and a partially enlarged view of the circular diffraction grating 140.

Referring to FIGS. 1 through 4, a polarization measuring device 100, according to at least this example embodiment, may include a diffraction grating 140 and/or a detector 150. The diffraction grating 140 may be a circular diffraction grating and will be discussed as such herein. However, example embodiments are not limited to a circular shaped diffraction grating. To the contrary, the diffraction grating 140 may have any suitable shape.

The circular diffraction grating 140 may include a diffraction plate 142 and a supporting plate 146. The diffraction plate 142 may be a flat or substantially flat plate having circular gratings 144 arranged, for example, at the center. The diffraction plate 142 may be formed in a circular shape, and be composed of, for example, Si₃N₄, SiO₂, any equivalent or substantially equivalent material. The thickness of diffraction plate 142 may be between about 0.5 and about 10 μm, inclusive.

The circular gratings 144 may have an interval L that approximates a wavelength of irradiated light. As shown in FIG. 4, the interval L of the circular gratings 144 refers to a width of the grating with a grating pattern formed therein. For example, when using a wavelength of about 633 nm, which is the wavelength of a He—Ne laser, the circular gratings 144 may have an interval L of about 633 nm or an interval L between about 600 and about 700 nm, inclusive.

The circular gratings 144 of the diffraction plate 142 may be configured by forming circular slits having a desired depth H. In one example, the slits having a depth H may be formed at the center of the diffraction plate 142 at regular (e.g., uniform or recurring) intervals using an electron beam (e-beam) to form the circular gratings 144. By adjusting the interval L and/or the slit thickness H of the circular gratings 144, the transmittance of the incident light may be adjusted.

The supporting plate 146 may be attached to (or alternatively, provided under) the diffraction plate 142 to support a thinner diffraction plate 142. The center of the supporting plate 146 may be void or removed to expose the circular gratings 144. In one example, a portion of the supporting plate below the circular gratings 144 may be void, and the supporting plate 146 may have a thickness and support the diffraction plate 142. Because the portion of the diffraction plate 142 in which the circular gratings 144 are formed is empty or substantially empty, light may pass there through. The supporting plate 146 may be a flat or substantially flat plate having a thickness. For example, the supporting plate 146 may be a Si substrate or the like. Although discussed herein as a diffraction plate, the diffraction plate 142 may also be referred to as a polarization plate.

Because the circular diffraction grating 140 has gratings arranged in a circular (or alternatively a substantially circular, e.g., elliptical) manner, the incident light may be diffracted in all or substantially all directions. The circular diffraction grating 140 may have gratings including a constant or substantially constant interval L and a slit thickness. When light passes through the gratings, the light may be diffracted, for example, directly or interferentially diffracted. In this example, by adjusting the interval L and/or the slit thickness H, the transmittance of the circular diffraction grating 140 may be adjusted according to the polarization directions of the incident light. In at least one example embodiment, transmittance in one or more particular directions may be larger than transmittance in other directions. In this example, the diffraction gratings may perform the same or substantially the same function as a polarizer.

According to at least this example embodiment, the circular diffraction grating 140 may have gratings formed in a direction radiating from the center and surrounding the center in all or substantially all directions. By adjusting the interval L and/or slit depth H of the circular diffraction grating 140 to increase transmittance in one or more directions, when light transmits the circular diffraction grating 140, the light may be diffracted in all or substantially all directions. Therefore, even when the circular diffraction grating 140 is not rotated, the polarization state in all or substantially all directions may be seen simultaneously.

Referring back to FIG. 1, the detector 150 may detect the distribution of the intensity of light passing through the circular diffraction grating 140. Various kinds of optical elements may be used as the detector 150. For example, the detector 150 may be a charge coupled device (CCD), an MOS controlled thyristor (MCT) or the like. In at least this example embodiment, the detector 150 may collect the light diffracted in all or substantially all directions by the circular diffraction grating 140 to detect and display data regarding the polarization of the light two-dimensionally. The data may be displayed on a two-dimensional screen, and the polarization level or state of light incident on the circular diffraction grating 140 may be extracted (e.g., directly extracted) using the displayed data. In at least one example embodiment, the polarization state of the incident light may be displayed on the screen.

When measuring the polarization of light using the polarization measuring device 100, according to at least this example embodiment, productivity may be increased and/or the polarization state of light may be measured more effectively.

According to the related art, a polarization state of light is measured by observing a polarized direction of light while rotating the polarization plate. However, using polarization measuring devices, according to at least some example embodiments, the polarization state in all or substantially all directions may be measured by diffracting light in all or substantially all directions, without separately operating or rotating the circular diffraction grating 140. This may reduce measuring time and/or cost because rotation equipment need not be used and/or included.

Further, in at least this example embodiment of the polarization state measuring device 100, light that is diffracted in all or substantially all directions may be detected by the detector 150. Accordingly, the polarization state may be more easily observed, thereby rapidly and/or effectively measuring the polarization state of light.

Hereinafter, an ellipsometer according to another example embodiment will be described with regard to FIGS. 2 to 5.

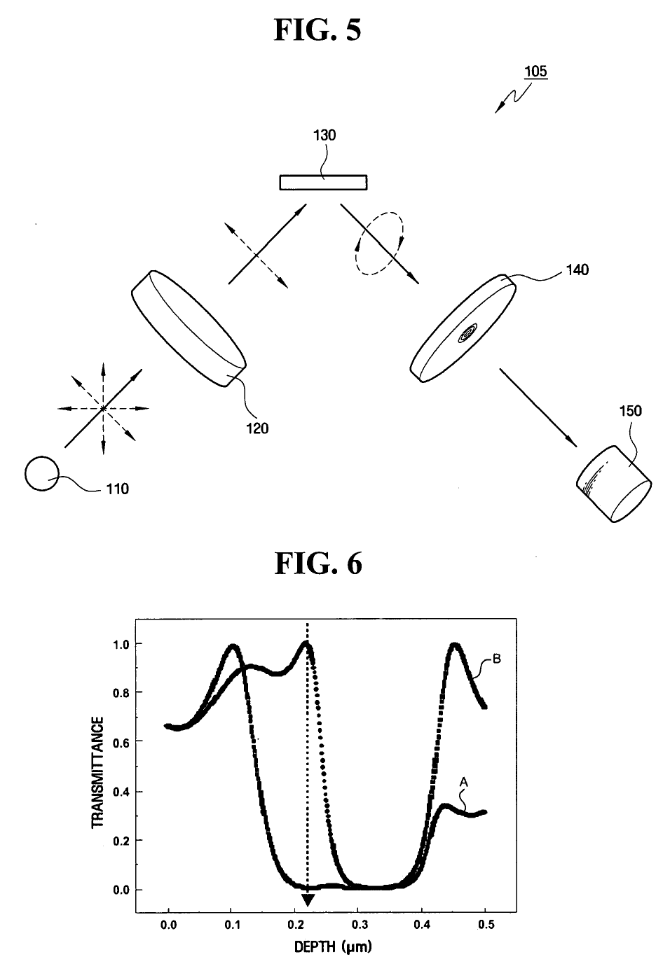

FIG. 5 is a diagram illustrating this example embodiment of an ellipsometer. Referring to FIG. 5, an ellipsometer 105 may include a light source 110, a polarizer 120, a diffraction grating 140 and/or a detector 150. For example the ellispometer may include a light source 110, a polarizer 120 and the polarization state measuring device 100 of FIG. 1.

Referring to FIG. 5, the light source 110, (e.g., a laser lamp or any other suitable type of lamp) may emit light toward the polarizer 120. The light source 110 may be, for example, a deuterium (D₂) lamp, a xenon (Xe) lamp, a quartz tungsten halogen (QTH) lamp, or the like.

The polarizer 120 may polarize the light by transmitting a component of the light having a specific polarization, while shielding other components of the emitted light. The polarizer 120 may include a polarizing film formed by extending a film such as a polyvinyl alcohol (PVA) film (or the like) in a specific direction. The polyvinyl alcohol film may be applied with, for example, iodine, pigment or the like.

The circular diffraction grating 140 may be the circular diffraction grating described above with regard to FIGS. 1-4, however, any other suitable diffraction grating may be used. As noted above, the circular diffraction grating 140 may include a diffraction plate 142 and/or a supporting plate 146. The circular diffraction grating 140 may adjust an interval L and/or the slit thickness H thereof to adjust transmittance, and the transmittance may be adjusted according to the polarization direction of incident light. Because the circular diffraction grating 140 has gratings arranged in a circular or substantially circular manner, the incident light may be diffracted in all or substantially all directions. The light polarized through the polarizer 120 may be reflected from a work piece 130 thereby changing the polarization state of the light. Further, when the polarized light passes through the circular diffraction grating 140, the light may be diffracted in all or substantially all directions, and therefore, the polarization state of the light in all or substantially all directions may be seen without rotating the circular diffraction grating 140.

The detector 150 may detect the intensity distribution of light passing through the circular diffraction grating 140. For example, using the detector 150, polarization state data may be extracted (e.g., directly extracted) based on a two-dimensional distribution of the light intensity measured by the detector 150. In at least one example embodiment, the two-dimensional distribution of light intensity may be displayed on a two-dimensional screen. Various types of optical or photo reactive elements may be used as the detector 150. For example, the detector 150 may be a charge coupled device (CCD), a MOS controlled thyristor or the like. The detector 150 may collect the light diffracted by the circular diffraction grating 140, detect a two-dimensional distribution of the light and display the distribution light two-dimensionally. This data may be displayed on a two-dimensional screen, and data for measuring the polarization degree of the light incident on the circular diffraction grating 140 may be extracted (e.g., directly extracted).

Hereinafter, a method of measuring a polarization state according to an example embodiment will be described with regard to FIGS. 2 to 5. The solid line in FIG. 5 indicates the light path, and the dotted line indicates the polarization direction of the light.

Referring to FIGS. 2 to 5, the light source 110 may emit light, for example, non-polarized light toward a polarizer 120. When the emitted light passes through the polarizer 120, the light may be changed into polarized light having a specific or particular polarization state. The polarized light may be incident on and reflected by the work piece 130 and the polarization state of the light may change. The change in the polarization state may be caused by the interaction between the thin film layer of the work piece 130 and the emitted light. By analyzing the polarization state of the reflected light as compared with the polarization of the incident light, information regarding the work piece 130 may be obtained.

In order to analyze the polarization state of the reflected light, the reflected light may be diffracted by the circular diffraction grating 140. The circular diffraction grating 140 may diffract the light reflected from the work piece 130 so as to check the polarization state of the light. In at least this example embodiment, because the circular diffraction grating 140 has gratings arranged circularly, the light may be diffracted in all or substantially all directions. The diffracted light may be collected by the detector 150, and a two-dimensional distribution of a polarization state of the light may be detected. By displaying the distribution (or the detected polarization state) of the light on a two dimensional screen, data capable of measuring the polarization degree of the light reflected from the work piece 130 may be extracted (e.g., directly extracted).

According to at least some example embodiments, when the polarization of light is measured using an ellipsometer according to at least this example embodiment, the polarization state may be more rapidly and/or more effectively measured, and productivity may be increased.

When using the polarization measuring device according to at least this example embodiment in which light passes through the circular diffraction grating 140 without rotating the circular diffraction grating 140, the polarization state may be measured (e.g., immediately) so that the polarization state in all or substantially all directions may be detected and displayed two dimensionally. Accordingly, measuring time and/or cost may be reduced because the polarization measuring device need not include equipment for rotation.

An ellipsometer according to at least some example embodiments may measure changes in the polarization state of light to be used for studying a surface, a film structure, physical properties, mineral properties of a work piece, etc. Further, the ellipsometer may be used for measuring and/or analyzing a thickness, a density, a refractive index, a ratio of materials for a thin film in semiconductor manufacturing processes, thin film manufacturing processes or the like. For example, the ellipsometer may be used to measure a thickness of a contamination film or an oxide film formed on a photomask used during a photo process, and/or a thickness of a thin film in a deposition process. Because the change in the polarization state is visible through a screen detected by the detector 150 using an ellipsometer according to at least some example embodiments, the change in the thickness of the thin film may be measured during semiconductor device manufacturing processes. For example, ellipsometers according to at least some example embodiments may be used as an in-situ polarization spectrometer.

FIG. 6 is a graph illustrating a transmittance of TE wave and TM wave versus a depth of a slit of a diffraction grating. In FIG. 6, the wavelength of the incident light is 633 nm, and the interval between the diffraction gratings is 600 nm. Graph ‘A’ indicates a transmittance of a TE wave, and graph ‘B’ indicates a transmittance of a TM wave.

Referring to FIG. 6, the change in transmittances of the TE wave and the TM wave may be confirmed based on the difference of the depths of the diffraction gratings. For example, when the thickness of the diffraction gratings is 0.22 μm, the transmittance of the TM wave may be relatively large and the transmittance of the TE wave may be about or close to zero. For example, when the thickness of the diffraction grating is 0.22 μm, a diffraction grating transmitting only the TM wave may be formed.

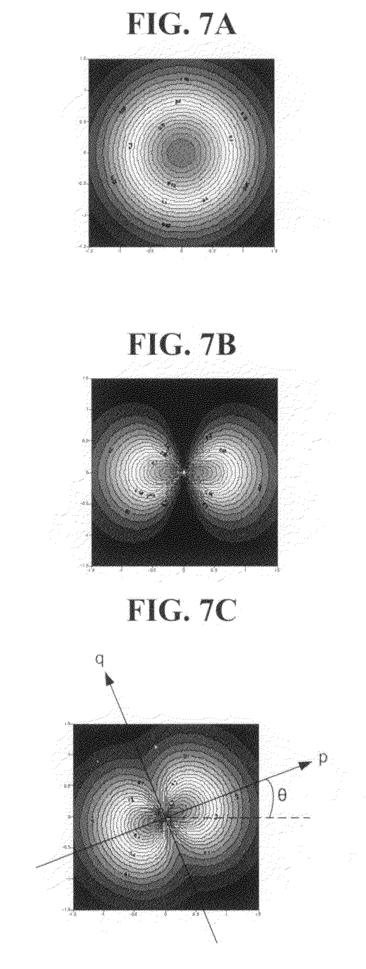

FIGS. 7A to 7C are views illustrating images of a polarization state of irradiated light displayed on a detector in the polarization state measuring device according to an example embodiment.

FIG. 7A is a view illustrating an image displayed on a detector when non-polarized light is irradiated onto a circular diffraction grating in the polarization measuring device according to an example embodiment, FIG. 7B is a view illustrating an image displayed on a detector when linearly polarized light is irradiated onto a circular diffraction grating in the polarization measuring device according to an example embodiment, and FIG. 7C is a view illustrating an image displayed on a detector when elliptically polarized light is irradiated onto a circular diffraction grating in the polarization measuring device according to an example embodiment.

Referring to FIGS. 7A to 7C, the visibility of the polarization state of light when light passes through a circular diffraction grating whose interval and height are appropriately controlled may be confirmed.

In FIG. 7A, because non-polarized light is incident on the circular diffraction grating, the light is uniformly diffracted in all directions. In FIG. 7B, because light having a specific polarization state is incident on the circular diffraction grating, the light is diffracted in one direction. In FIG. 7C, because elliptically polarized light is incident on the circular diffraction grating, the light is distributed in both the p-direction and the q-direction. In this case, the p-direction where the majority of the light is distributed (e.g., wherein the light is mainly distributed) is inclined at θ. Therefore, the polarization state of the incident light may be analyzed based on the area that the light is distributed in the p-direction, the q-direction and θ.

According to the above-described example embodiments of semiconductor manufacturing equipment, polarization measuring speed may be increased and/or cost may be reduced. In addition, because the polarization state in all directions may be checked, for example, immediately, the polarization state may be measured more rapidly and/or effectively. Further still, because the change in the polarization state may be more easily confirmed, ellipsometers according to at least some example embodiments maybe used as in-situ polarization spectrometers.

Although example embodiments have been described in connection with the, it will be apparent to those skilled in the art that various modifications and changes may be made thereto without departing from the scope and spirit of the present invention. Therefore, it should be understood that the above example embodiments are not limitative, but illustrative in all aspects.

What is claimed is:

1. A polarization measuring device comprising:
a diffraction grating configured to diffract incident light to check the polarization state of the light; and
a detector configured to receive the diffracted light and display data indicative of the polarization state of the light.

2. The polarization measuring device of claim 1, wherein the diffraction grating includes,
a grating having slits, the diffraction grating having an adjustable transmittance, the transmittance being adjustable according to a polarization direction of the light by adjusting at least one of an interval and a slit depth of the grating.

3. The polarization measuring device of claim 1, wherein the diffraction grating is a circular diffraction grating.

4. The polarization measuring device of claim 3, wherein the circular diffraction grating diffracts the incident light in all directions.

5. The polarization measuring device of claim 4, wherein the detector detects a two-dimensional distribution of the diffracted light intensity.

6. The polarization measuring device of claim 5, wherein data indicative of a polarization state of the diffracted light is directly extracted using a two-dimensional screen displaying the two-dimensional distribution of the light intensity.

7. An ellipsometer comprising;
a light source configured to emit light;
a polarizer configured to polarize the emitted light and direct the polarized light toward a work piece; and
the polarization measuring device of claim 1.

8. The ellipsometer of claim 7, wherein the diffraction grating includes,
a grating having slits, the diffraction grating having an adjustable transmittance, the transmittance being adjustable according to a polarization direction of the light by adjusting at least one of an interval and a slit depth of the grating.

9. The ellipsometer of claim 7, wherein the diffraction grating is a circular diffraction grating.

10. The ellipsometer of claim 9, wherein the circular diffraction grating diffracts the light reflected from the work piece in all directions.

11. The ellipsometer of claim 10 wherein the detector detects a two-dimensional distribution of the diffracted light intensity.

12. The ellipsometer of claim 11, wherein data indicative of a polarization state of the diffracted light is directly extracted using a two-dimensional screen displaying the two-dimensional distribution of the light intensity.

13. The ellipsometer of claim 7, wherein the detector is a charge coupled device or a MOS controlled thyristor.

14. The ellipsometer of claim 7, wherein the polarizer polarizes the light to have a specific polarization state.

15. A method of measuring a polarization state of light, the method comprising;
diffracting incident light to check a polarization state of the light by transmitting the light through a diffraction grating; and
detecting and displaying data indicative of the polarization state of the diffracted light at a detector.

16. The method of claim 15, wherein the method further including,
adjusting a transmittance according to a polarization direction of the light by adjusting at least one of an interval and a slit depth of the grating.

17. The method of claim 15, wherein the diffraction grating is a circular diffraction grating.

18. The method of claim 17, wherein the incident light is diffracted in all directions.

19. The method of claim 18, wherein the data is a two-dimensional distribution of the diffracted light intensity.

20. The method of claim 19, further including,
displaying the two-dimensional distribution of the diffracted light intensity, and
directly extracting data for measuring a polarization degree of the incident light using the displayed two-dimensional distribution of the diffracted light intensity.

21. The method of claim 15, further including,
emitting light,
polarizing the light, and
directing the polarized light toward a work piece to generate the incident light, the incident light being the light reflected by the work piece.

22. The method of claim 21, further including,
adjusting a transmittance according to a polarization direction of the light by adjusting at least one of an interval and a slit depth of the grating.

23. The method of claim 21, wherein the diffraction grating is a circular diffraction grating.

24. The method of claim 23, wherein the incident light is diffracted in all directions.

25. The method of claim 24, wherein the detector two-dimensionally detects the diffracted, incident light.

26. The method of claim 25, further including,
displaying the two-dimensional distribution of the diffracted light intensity, and
directly extracting data for measuring a polarization degree of the incident light using the displayed two-dimensional distribution of the diffracted light intensity.

27. The method of claim 21, wherein the detector is a charge coupled device or an MOS controlled thyristor.

28. The method of claim 21, wherein the polarizer polarizes the light to have a specific polarization state.
